(19) United States
(12) Patent Application Publication
(10) Pub. No.: US 2009/0044217 A1
(43) Pub. Date: Feb. 12, 2009

(54) System and methods for network TV broadcasts for out-of-home viewing with targeted advertising

(76) Inventors: R. Steven Lutterbach, Indiana, IN (US); Ryan Lutterbach, Chicago, IL (US); Fred Smith, Claredon Hills, IL (US); Luke Smith, Claredon Hills, IL (US)

Correspondence Address: Michael J. Femal;McDonald Hopkins LLC, Suite 590, 640 North LaSalle Street,, Chicago, IL, 60610, US

(21) Appl. No.: 12/002,416

(22) Filed: Dec. 17, 2007

Related U.S. Application Data
(60) Provisional application No. 60/875,435, filed on Dec. 18, 2006.

(51) Int. Cl. H04N 7/10; H04N 7/025

(52) U.S. Cl. 725/34; 725/35

(57) ABSTRACT

A television broadcasting system and methods that manages the insertion of targeted advertisements and other messages into live satellite or Internet broadcasts or other types of broadcasts into out-of-home locations such as health clubs. The insertion of targeted advertisement and other messages are accomplished by a satellite service provider purchasing live network broadcasting feeds with a license to strip out existing commercial advertisements and replace them with targeted advertisements to match the demographics of the viewing audience at health clubs and other non-home locations nationally, regionally and locally where the viewer is unable to change or delete the targeted advertisements while viewing the live broadcast programming from the networks.

### CROSS-REFERENCE TO RELATED APPLICATIONS

This application claims priority from U.S. Provisional Patent Application No. 60/875,435 entitled “SYSTEM AND METHODS FOR NETWORK TV BROADCASTS FOR OUT-OF HOME VIEWING WITH TARGETED ADVERTISING” filed on Dec. 18, 2006, which is hereby incorporated by reference in its entirety.

### FEDERALLY SPONSORED RESEARCH OR DEVELOPMENT

Not applicable

### TECHNICAL FIELD

The invention relates generally to the broadcasting of live network programming including advertising content where existing advertising content is swapped-out and exchanged for targeted advertising content, then broadcast to specified audiences whose demographics are used to select the targeted advertising content.

### BACKGROUND OF THE INVENTION

Today's society offers many activities that form groups of people that share common demographic traits. For example, people that regularly attend select health clubs tend to be young, single, health-conscious individuals with disposable income. Today, such health clubs across the country commonly include unedited network and cable television programs or loop programming, which repeats over again with the same commercial advertisements each time. Generally the viewing audience at the health club is working out and simply tunes out repetitive commercial advertisements that play over and over again in canned loop programming. In fact, a common sight at health clubs with repetitive loop programming or even live broadcasting that regularly repeat commercials is that the viewing audience is often entertained by other devices, such as iPods®, cellular phones, and the like. The lack of attention paid to live broadcasting or looped programming by this potential television audience represents a lost opportunity for advertisers to reach this desirable audience.

Advertisers generally prefer to run advertisements in conjunction with broadcast programming that draws a targeted audience to match the advertisers' products and services. Advertisers also prefer to have advertisements displayed to individuals about whom there is some amount of demographic knowledge. When purchasing advertising opportunities, a given advertiser might desire to have different advertising supplied to individuals of different age groups or living in different geographic locations.

In one example, a certain health club may have an audience that shares common demographic traits, such as generally being young, single, professional individuals with disposable income. Such a health club may be located in the downtown of a major city such as New York, Chicago, or Los Angeles. Advertisers would benefit from such a targeted audience by providing commercials related to products and services for sky diving, scuba diving, mountain climbing, skiing, and other such sport activities.

In another example, a certain health club may cater to older individuals such as senior citizens. Such a health club may be located in a retirement community such as Sun City, Ariz. or Lakeland, Fla. Advertisers would benefit from such a targeted audience by providing commercials related to products and services for pharmaceuticals and supplemental Medicare insurance. Advertisers would be interested in accessing such targeting viewing audiences with commercial advertisements.

The present invention is provided to solve the problems discussed above and other problems, and to provide advantages and aspects not provided by prior advertisement systems and methods that attempt to target a given audience. A full discussion of the features and advantages of the present invention is deferred to the following detailed description, which proceeds with reference to the accompanying drawings.

### SUMMARY OF THE INVENTION

Currently, there are no other systems or methods that are comparable to the present invention for systems and methods that insert advertisements into broadcasts directed to select groups of people, such as health club members. In an embodiment, the present invention provides a live satellite television broadcast of the nation's most popular television content to health clubs and other high-traffic venues throughout the world. First, live broadcast television networks sell their live broadcast programming content to a satellite provider for health clubs. Once the content is purchased, there is a “swap-out” of existing national advertising with custom targeted advertising, resulting in an experience that is seamless to the viewing audience at the health clubs.

Through the system and methods of the present invention, advertisers are assured that captive, friendly audiences are watching their commercials and that TiVo® or similar digital video recording systems are not used to avoid viewing the advertisements. Unlike viewers of at-home broadcast television, viewers in the health clubs do not have the ability to change channels, skip commercials or time-shift their viewing. The technology of the present invention allows advertisers to create specific, market coverage patterns; position program-specific messages; and utilize all forms of commercial lengths.

Advertisers display advertisements in health clubs in the form of posters and billboards; however, health club patrons view billboards or posters located in the health clubs only for short periods of time. Live television programming with targeted advertisement insertions holds health club patrons' attention for significant periods of time. In fact, many treadmill users do not taking their eyes off television monitors during their workouts because they choose to focus on what they are watching as they attempt to block out the stress of their workouts.

Therefore, the present invention is a system for the swapping or switching of existing commercials in live television programming provided by any broadcasting network with different and targeting commercials that are broadcast with the live programming into a specific location, such as a health clubs. The live broadcast programming that includes the new commercials may be broadcast in national, regional,

An embodiment of a method of the present invention begins with the negotiation to purchase the commercial rights for the programming content from various television networks. Included within the agreements to purchase the live content is a grant for the purchaser to resell the commercial advertisement time for out-of-home viewers in a manner that does not interfere with a network's prepaid advertisements agreements targeting in-home viewers. Once the commercial rights to the broadcast content are purchased, the purchaser of the content may then sell commercial time to any advertiser, and advertisers may purchase commercial time in any time increments.

With the purchase of rights to broadcast content and commercial time sold to advertisers, the purchaser, such as a satellite provider for example, may swap-out, switch-out, or otherwise exchange advertising content sent with the broadcast signal for advertising content that targets the demographics of groups gathered at targeted viewing locations. For example, advertisements targeting young, single professions may be sent with a broadcast signal to a health club whose clientele matches those demographic traits.

The swap-out of advertising content may occur at the purchaser's receiving and distribution facility, such as the purchaser's headend facility. At such a facility, the advertisement commercials sent by the network with the broadcast signal may be removed and replaced with targeted commercials before the broadcast signal is relayed to the intended audience. Such an edited or modified broadcast signal may be relayed from the purchaser's headend facility to the purchaser's satellite, and then may be sent from the purchase's satellite to satellite-dishes that are positioned on or otherwise associated with buildings or other such facilities throughout the world, such as health clubs for example.

Only health clubs that subscribe to the purchaser's broadcast service receive the broadcast signal through installed satellite-dishes equipped with appropriate receiving equipment and security devises. In an embodiment, the receiving equipment includes a satellite-dish that may be, for example, 1.0, 1.2, or 1.8 meters in diameter, receiver boxes, and various modulators. The broadcast signal progresses to the health club through the satellite-dish and receiver boxes, through the modulators, and on to television monitors that are strategically placed throughout the health club for members to view during workouts or breaks. Although the advertising content of the broadcast is swapped-out, it is imperceptible to the viewer that commercials sent with the broadcast from the network have been replaced with advertisements that target the viewer.

In an embodiment, additional receiving equipment may be located at the health club. Such equipment would be capable of swapping-out advertisement content prior to health club members viewing the broadcast signal. The additional receiving equipment may include a large internal hard drive, such as a 100-gigabyte hard drive, for storing content such as video clips, text and graphics. Such content may then be inserted as customized advertisement into the broadcast signal at the intended viewing location. Such an embodiment results in customized and targeted advertisements inserted into a live feed for a seamless broadcast to be viewed by health clubs members.

There are substantial advantages to storing advertisement content locally at a health club location. For example, a series of health clubs may receive the same broadcast signal from a satellite provider headend; however, it may be desirable that the advertising content for each health club be customized locally. For example, a health club with an older clientele may locally customize advertisements that appeal to that demographic group, while a health club located next door with a younger clientele may locally customize advertisements that appeal to that demographic group. In addition, a health club that appeals to a broad range of people, but may draw older or retired crowds that workout during the daytime, while a younger professional crowd may workout later in the evening, may customize the advertisement depending on the time of day the advertisement will be shown. Such arrangements may improve an advertiser's ability to reach a targeted audience with the right demographics to view certain commercial advertisements and maximize the effectiveness of its advertisements.

In accordance with the present invention, in one embodiment, a service provider system and methods with provisions for delivering network broadcasts with targeted advertisements or other messages to match the demographic characteristics of the majority viewers at out-of-home locations are provided. Such systems and methods may comprise purchased network programming with commercial advertisements being received via satellite transmission from the network broadcast; a headend satellite receiving station for enabling the service provider to strip out the existing commercial advertisements from the network programming and replace the commercial advertisements seamlessly within the programming with targeted advertisements; an uplink to a service provider satellite for transmitting the programming with the inserted targeted advertisements; a downlink from the service provider satellite for transmitting the programming with the targeted advertisements; a satellite receiver for receiving the transmitted programming with the targeted advertisements at a final location; and a display connected to the receiver for displaying the network programming with the targeted advertisements at the final location wherein the viewer is unable to delete the targeted advertisements while viewing the network programming.

In another embodiment, a television broadcasting system and methods that manages the insertion of targeted advertisements and other messages into live satellite or Internet broadcasts or other types of broadcasts into out-of-home locations such as health clubs, libraries, banquet halls and other locations is provided. The insertion of targeted advertisements and other messages are accomplished by a satellite service provider purchasing live network broadcasting feeds with a license to strip out existing commercial advertisements and replace such advertisements with targeted advertisements to match the demographics of the viewing audience at health clubs and other non-home locations nationally, regionally, and locally, where the viewer is unable to change or delete the targeted advertisements while viewing the live broadcast programming from the networks.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an exemplary schematic illustration of a system of the present invention;

FIG. 2 is an exemplary schematic illustration of a receiving module at a viewing destination of the present invention;

FIG. 3 is an exemplary schematic illustration of an acquisition of broadcast and advertising content system of the present invention;

FIG. 4 is an exemplary schematic illustration of a headend operation system of the present invention;

FIG. 5A is an exemplary schematic illustration of a transmission via satellite to a viewing destination of the present invention;

FIG. 5B is an exemplary schematic illustration of a transmission via the Internet to a viewing destination of the present invention;

FIG. 6 is an exemplary schematic illustration of a transmission via regional headend to a viewing destination of the present invention;

FIG. 7 is an exemplary schematic illustration of a final viewing location accessible via satellite in accordance with the present invention; and

FIG. 8 is an exemplary schematic illustration of a final viewing location accessible via an internet protocol in accordance with the present invention.

### DETAILED DESCRIPTION

While this invention is susceptible of embodiments in many different forms, the drawings show and the description describes in detail preferred embodiments of the invention with the understanding that the present disclosure is to be considered as an exemplification of the principles of the invention and is not intended to limit the broad aspect of the invention to the embodiments illustrated.

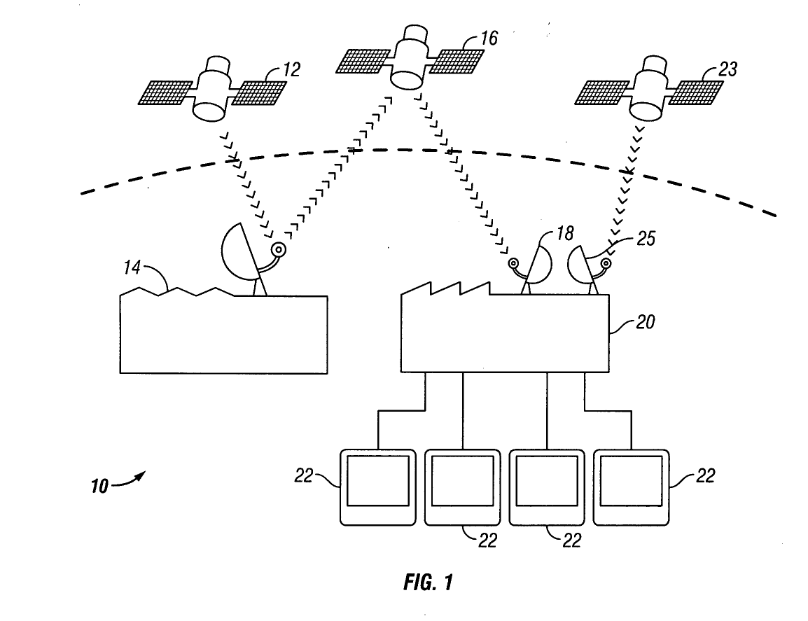

FIG. 1 illustrates an exemplary embodiment of a broadcasting system 10. Such a system 10 may be used to receive a broadcast signal from a broadcast content provider such as, for example, CNN, ABC, ESPN, or any other network; modify that broadcast content; and relay the modified content to end users for viewing. An operator of the system 10 may purchase the rights to the broadcast content from a network or may partner with the network to relay the content to end views. A system operator may be, for example, a satellite service provider that provides broadcast signals to viewers through satellite technology. In another embodiment, the system operator may be an Internet service provider that provides broadcast content via the Internet to viewers. In another embodiment, the system operator may be any service provider that provides broadcast content through any technology, whether through physical cables, through wireless technology, a combination of the two, or any other method of providing broadcast content to a viewer.

In the exemplary embodiment of FIG. 1, the system operator may receive broadcast content from a network in the form of a broadcast signal transmitted or otherwise sent from a signal directing device, such a the network's satellite 12, to the operator's receiving facility or headend 14. In one embodiment, the headend may be similar to a typical CATV installation. Once the broadcast content is received at the headend 14, the system operator may swap-out, switch-out, or otherwise exchange the advertising content received from the network with targeted advertisements directed to the intended end viewers of the content. Once the advertising is customized, the modified broadcast signal may be sent from the headend 14 to a satellite 16 controlled by the system operator. The operator's satellite 16 may then redistribution the modified broadcast signal in real time to its subscribers. In another embodiment, modified broadcast signal may be time-delayed at the headend 14 or the operator's satellite 16 before delivery of the signal to subscribers.

The operator's satellite 16 may relay the broadcast signal to subscribers in any location throughout the world. One example of a subscriber is a health club. The subscriber may receive the broadcast signal through a broadcast signal-receiving device. For example, a subscriber may receive the signal through a receiving device, such as a satellite-dish 18 positioned on top of a facility or building 20 used by the subscriber. Although a receiving device is described and illustrated as a satellite-dish, it will be readily understood that a receiving device may be any device or technology capable of receiving broadcast content such as an antenna and the like.

The broadcast signal may be arranged such that the signal is compatible or complimentary to an existing audio/visual system at the health club. In such an arrangement, a live broadcast signal that includes the modified advertisement content targeted to the health club's clientele appears unobtrusively and seamlessly to the viewing club members. Such content may be displayed on any number of video display devices, such as televisions or monitors 22, distributed throughout the subscriber's facility 20. The non-advertisement content that is provided by the content provided, such as CNN, remains unaffected by the modifications to the broadcast made by the system operator.

The subscriber may receive other content from other providers as well. For example, broadcast signals may be relayed from other satellites 23 unassociated with the system operator to a signal-receiving device 25 at the subscriber without affecting the broadcast signal sent by the system operator.

The system operator may work with various network partners to broadcast the networks' broadcast signals through a private satellite distribution system. In one example, the system operator hosts the networks on advanced satellite systems, such as Galaxy 16, which is an advanced satellite system within IntelSat's fleet of satellites. The core service of such a system is the full-time distribution of television programming that enables hundreds of broadcasters like the system operator of the present invention to reach growing television audiences at health clubs virtually anywhere in the world. The PanAmSatts global satellite and fiber capabilities of Intelsat serve as a robust resource for system operators to deliver broadcast signals globally, regionally, and locally. Such capabilities satisfy the requirements for distributing broadcast signals with targeted advertisements to subscribers anywhere in the world.

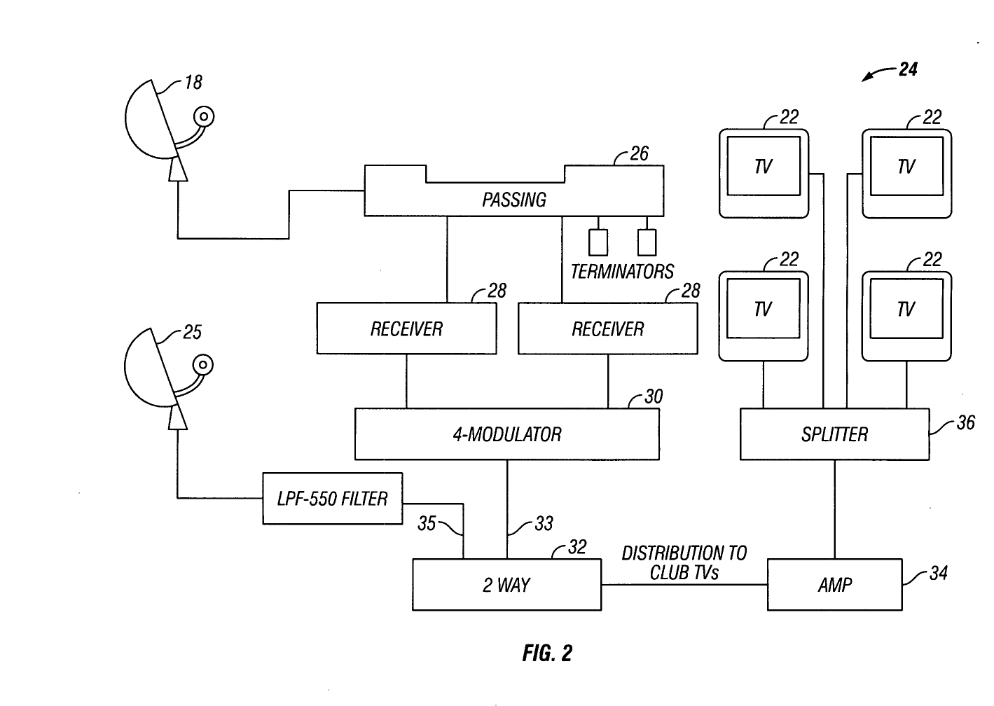

As shown in FIG. 2, in one exemplary embodiment the system 10 may be arranged to integrate with a subscribing health club's existing audio/visual equipment 24. For example, the broadcast signal from the system 10 may pass through a 4-way power passing circuit 26, which in turn is connected to a pair of receivers 28. The receivers 28 are connected to a 4-Modulator 30, which is connected to a 2-way connector 32. One input 33 of the connector 32 receives the system's 10 satellite broadcast signals and the other input 35 receives other broadcast content, such as traditional local television or cable service. Both signals may then be distributed to the health club amplifier system 34 that may lead to a splitter 36, which distributes the broadcast signals to multiple televisions and monitors 22.

Since the system 10 of the present invention compliments existing cable or satellite systems, the setup or integration of the system 10 will not interfere with the subscriber's existing audio/visual system 24 and is designed to easily connect to or disconnect from the subscriber's existing audio/visual system 24. In addition, in such an arrangement the broadcast signal from the system 10 will not be affected if the conventional cable or satellite system experiences interruption of service or other difficulties.

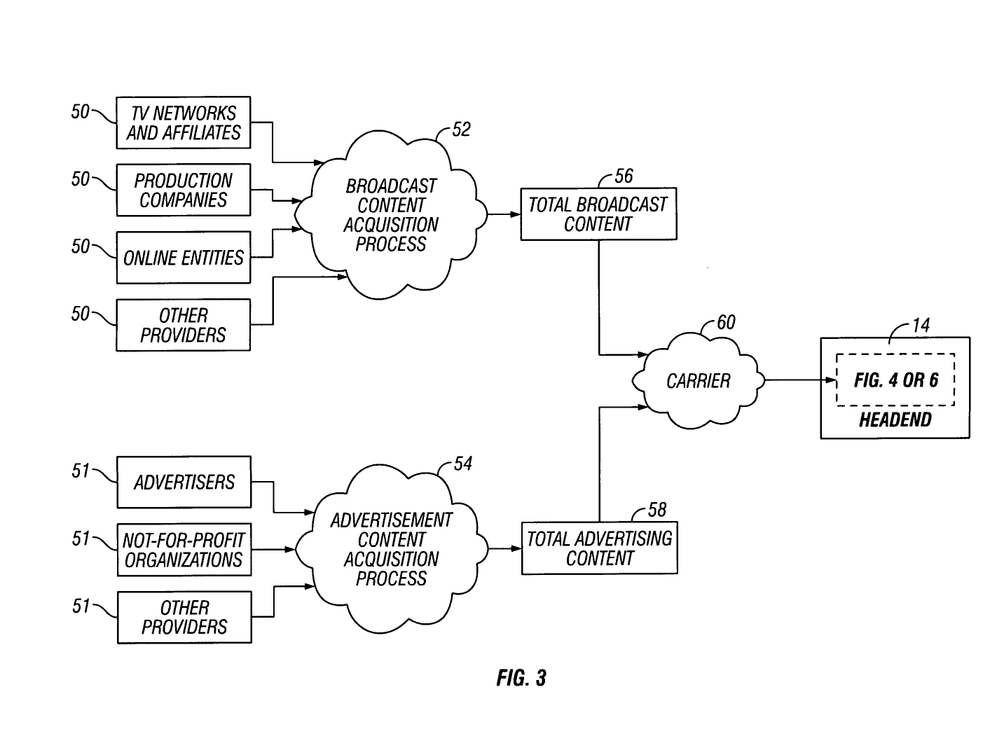

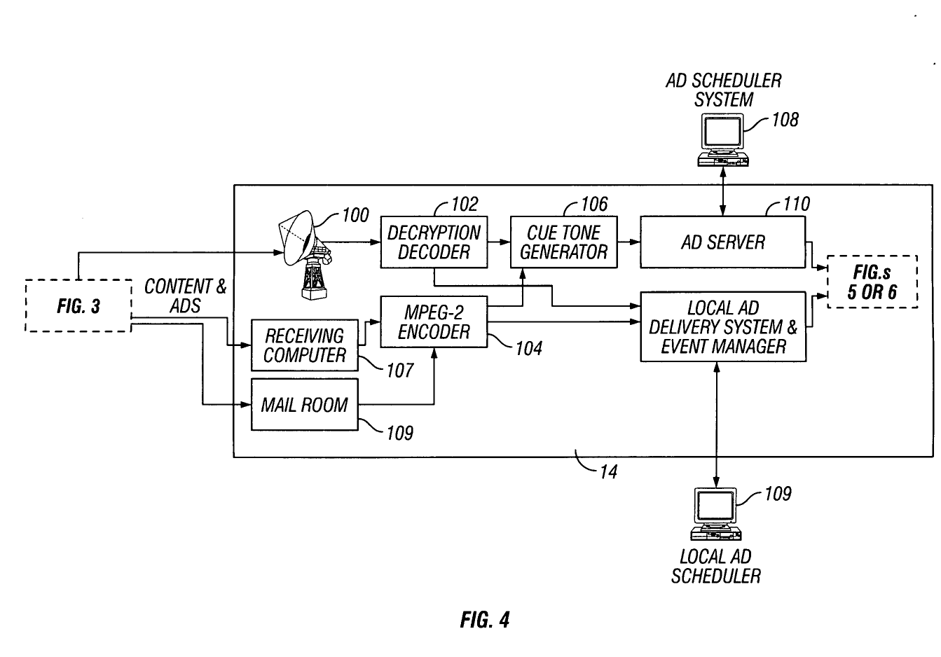

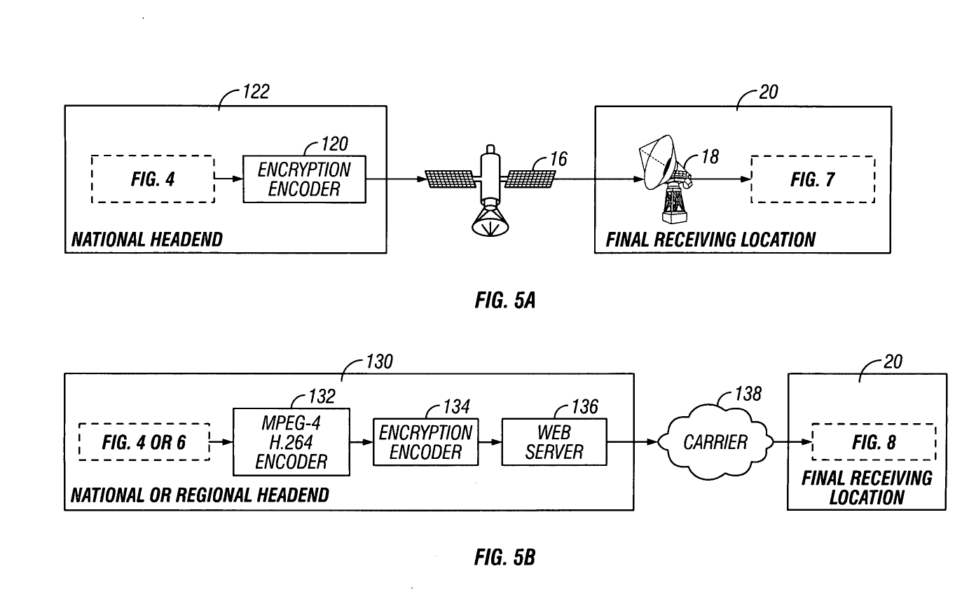

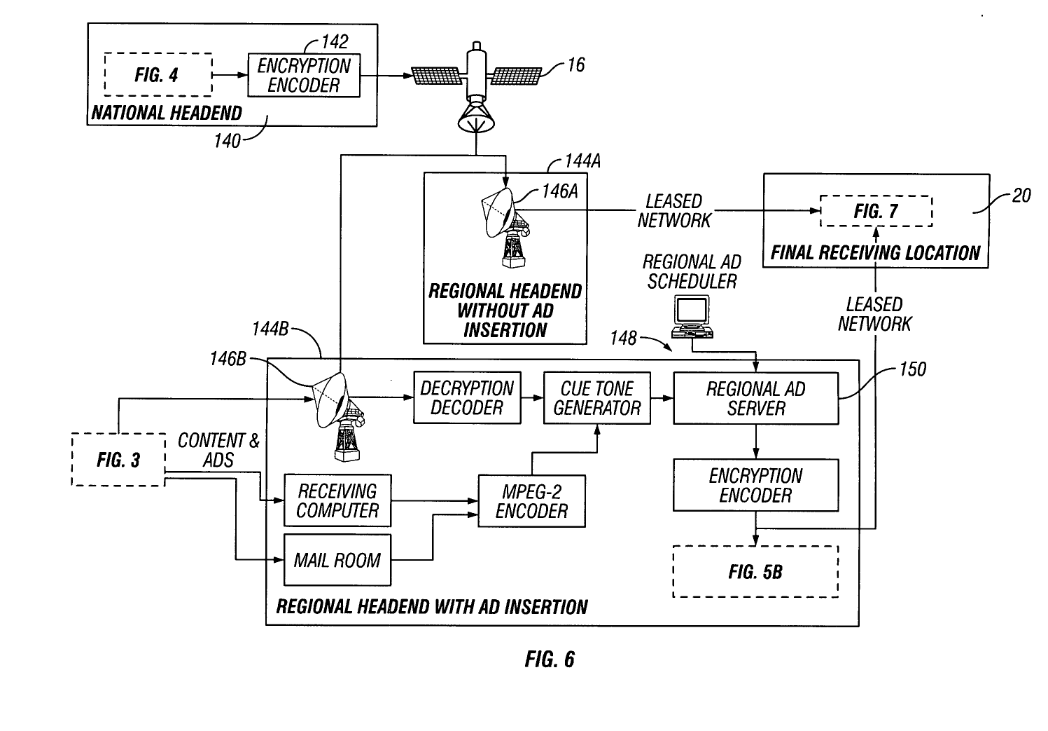

FIG. 3 illustrates an exemplary arrangement for acquiring broadcast content from broadcast providers and acquiring advertising content from advertisers. The broadcasting content may come from cable and television networks and their affiliates, production companies, online entities, and still other known providers. The acquisition of broadcasting content such as television shows, newscasts, sporting events, and the like, may be negotiated for, purchased from, or otherwise obtained from a variety of sources including, but not limited to, CNN, ESPN, ABC, CBS, NBC, MSNBC, CNBC, other television networks, local network affiliates, production companies, and other such providers and owners of pre-programmed content.

Pre-programmed content normally includes existing advertisements that the network or content provider has sold to its clients for in-home viewing. An agreement between the content provider and the operator of the system 10 may provide for the operator to replace or overwrite advertising content prior to relaying the broadcast content to the operator's out-or-house subscribers. The operator may package the broadcast content obtained from the various sources and make this packaged content available to its subscribers.

Referring again to FIG. 3, a variety of advertisement providers, such as advertisers, not-for-profit, and the like, may provide advertising content to be swapped-out with the advertisements provided by a television network's broadcast. The advertisement providers are a source of revenue during the advertisement acquisition process, which results in offsetting a portion of the system operator's expenses in operating the system 10. In one embodiment, the broadcast content and advertising content is provided by a carrier signal that is relayed to the operator's headend facility 14.

Acquisition of standalone content by the system operator includes individual items or collections of video, audio, and other such data content. Such content may be negotiated for, purchased from, or otherwise obtained from the previously mentioned sources, such as CNN, ESPN, ABC, CBS, NBC, MSNBC, CNBC, other such networks, local network affiliates, production companies. In addition, such content may be obtained from online entities such as Google, Yahoo, AOL, YouTube, or other such providers and owners of standalone content. In another embodiment, the system operator creates its own standalone content for use with broadcasting. Such content may be created internally or subcontracted to create audio, video or data content for broadcasting to subscribers, such as health clubs.

An exemplary arrangement described herein is illustrated in FIG. 3. Reference number 50 makes reference to sources of broadcasting content, and reference number 51 makes reference to sources of advertising content. The broadcast content is delivered to a broadcast content acquisition process 52, and the advertising content is delivered to an advertisement content acquisition process 54. The broadcast content is assembled in a total broadcast content location 56, and the advertising content is assembled in a total advertising content location 58, both of which are in communication with carrier signal logic 60 that provides the broadcast and advertising content to the headend 14.

Acquired advertising content, such as for example commercial advertisements, may be inserted into existing commercial breaks within pre-programmed content or may be inserted into new breaks in programming created from individually acquired standalone content. Commercial advertisement time in all programming is sold or donated to advertisers, not-for-profit organizations, and other organizations. The system operator may also retain a portion of the commercial advertising time for its own use. Commercial advertisements may be sold or donated in any time increment. Branded entertainment is advertisement time and programming time that is sold or donated to advertisers, not-for-profit organizations and other organizations or retained by the system operator. Such time is sold or donated in any time increment for branded entertainment.

The system operator headend facility 14 serves as a central control device to provide centralized functions such as remodulation, retiming, message accountability, contention control, diagnostic control, and access to subscriber's gateways. Third-party providers and advertisers may choose to encode and encrypt content to minimize file size and to insure signal security and identification during transportation to and receipt by the headend 14. Pre-programmed content may be prepared by the content provider with the insertion of electronic cue-tones for proper handling of advertisement insertions at the headend 14. Cue-tones are placed at both empty breaks and breaks that have previously existing advertising.

Methods of transporting and transmitting broadcast content and advertising content to and from the headend 14 include, but are not limited to, internet protocol, cable, telephone, radio frequency signal, and media such as videotape or DVD sent via parcel post. Broadcast content is typically transported from the content provider to the headend 14 via satellites that are owned, leased, or controlled by the content provider to receiving equipment at the headend 14. Generally, it is more likely that advertising content is transported from the advertiser to the headend 14 on videotape or DVD via parcel post.

FIG. 4 illustrates an embodiment of the operation of an exemplary headend 14. Reception and preparation of broadcast and advertising content at the headend 14 is an important function within the system 10 and methods of using the system 10. Broadcast and advertising content may be received at the headend 14 via any methods including, but not limited to, satellite transmission, the Internet, radio frequencies, other wired and wireless protocols, and recordable media sent via parcel post.

For content received via satellite, a signal-receiving device, such as a satellite-dish 100 located at the headend 14, may receive the signal coming from the third-party satellite to the headend 14. If necessary, the signal may be decrypted and decoded via a decoding device 102. It is preferable that broadcast and advertising content received at the headend 14 be in a convenient format such as, for example, MPEG-2, MPEG-4, H.264, or the like. Alternatively, content and advertisements may be converted into a convenient format via an encoding device 104. Advertisements and standalone content may be assigned a unique identifier for convenience. Newly created or preexisting programming received without cue-tones may have cue-tones inserted by a cue-tone generator 106 such as, but not limited to, a Monroe DTMF Cue-Tone Encoder.

For content received via the Internet, a receiving computer or server 107 may receive the content from a content provider. It is preferable that broadcast and advertising content received be in a convenient format. If the content is not in a convenient format, the content may be sent to the encoding device 104 for convenient formatting. For content received via the mail, a mailroom 109 may receive the content from a content provider. If the content is not in a convenient format, the encoding device 104 may format the content.

FIG. 4 also illustrates exemplary embodiments of scheduling targeted advertisements such as commercials into broadcast content. Commercials are scheduled into broadcast content by an advertisement scheduler system 108. The advertisement scheduler system 108 may include a national advertisement scheduler system, a regional advertisement scheduler system, and a local advertisement scheduler system. The national advertisement scheduler may be a software system that creates a schedule for all content and commercials that are broadcast for all national subscribers. The instructions may include operator commands instructing the device as to which files to play at which specified times and during which specified breaks. The device may uses a unique identifier associated with each item of broadcast or advertising content so that specific content may be identified.

A regional advertisement scheduler may be a software system that creates a schedule for all content and commercials that are broadcast for all the system operator's regional subscribers. The instructions may include operator commands instructing the device as to which files to play at which specified times and during which specified breaks. The local advertisement scheduler may be a software system that creates a schedule for all content and commercials that are broadcast to the system operator's individual subscribers, such as health clubs. The instructions may include operator commands instructing the device as to which files to play at which specified times and during which specified breaks. In addition, the instructions may include information regarding which end location or group of end locations should display the content or advertisements.

As illustrated in FIG. 4, a local advertisement scheduler 109 may be in communication with the headend 14 and operates in cooperation with the general advertisement scheduler 108, which may be the national advertisement scheduler. The national advertisement scheduler may schedule many of the advertisements on a national scale, but leave open a number of advertising spots to be filled in by the local advertising scheduler. It will be readily understood that a regional advertisement scheduler may also be in communication with the headend 14 as either the general advertisement scheduler 108 or as a subsequent scheduler that cooperates with a national advertisement scheduler, similar to the description of local advertisement scheduler 109.

The system 10 may be arranged such that a system operator's administrator may operate all elements of advertisement scheduler system 108 on-site at the headend location 14 or remotely via the Internet or other such technology. Additionally, a subscriber that desires to schedule broadcast or advertising content locally may operate the local advertisement scheduler 109 either directly or remotely. The local advertisement scheduler 109 may be located within the control of the subscriber for direct control, or may be located within the control of the system operator, who allows the scheduler to have remote access to the scheduler 109.

In an embodiment, insertion of scheduled broadcast or advertising content into a broadcast signal for national display is provided. With reference to FIG. 4, a broadcast signal is input into a national advertisement server 110. The national advertisement server 110 may include both hardware and software components. The national advertisement server 110, following the instructions provided by a national advertisement scheduler 108, is triggered by cue-tones in the signal to insert scheduled advertisements or additional broadcast content. For pre-programmed network content acquired from a third-party, an advertisement may be inserted in empty breaks or over existing commercials.

It will be understood that the exemplary arrangement in FIG. 4 may be arranged for regional or local display of broadcast signals. For regional display of broadcast signals, the system operator may use the same type of equipment and software to insert broadcast and advertising content regionally. In an embodiment, as shown in FIG. 6, a regional advertisement server 150 may be located at a secondary regional head end 144B.

For local display, broadcast and advertising content may be input into a local advertisement delivery system and event manager system, which may include both hardware and software systems, such as for example a DigiCipher Event Manager and Media Object Encapsulator. The local advertisement delivery system and event manager system may receive scheduling information from a local advertisement scheduler. Based on the schedule received and the broadcast and advertising content loaded into the device, the system sends the appropriate content and playback triggers to a designated satellite receiver with a local advertisement server. In one alternative as illustrated in FIG. 8, an IPTV receiver 164 with a local advertisement server located at the end viewing locations 20 may be used via the system operator's satellite or via the Internet.

It is preferable to report broadcast and advertising content insertion to advertisers. The advertisers may thus evaluate if the targeted audience received the appropriate advertisements. For advertisements inserted nationally and regionally, the national and regional advertisement schedulers may access the national and regional advertisement servers to view and create reports on the success or failure of advertisement insertion. Such a report may be used for verification and advertiser billing purposes. For broadcast and advertising content inserted locally, the local advertisement delivery system and event manager may receive and aggregate success and failure reports from all available local content distribution receivers at end locations. Data from local content distribution receivers may be received via an internet protocol over the Internet or phone lines. The local advertisement delivery system and event manager may access the local advertisement server to view and create reports on the success or failure of advertisement insertion. Such reports may be used for verification and advertiser billing purposes.

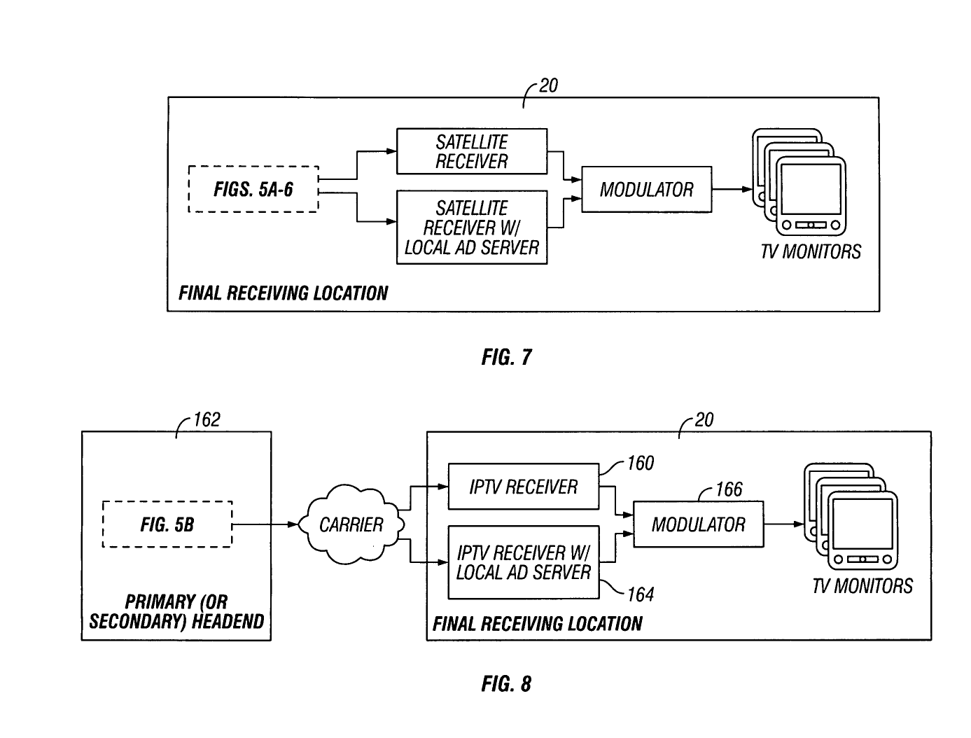

With reference to FIGS. 5A, 5B, and 6, additional embodiments are illustrated showing the transmission of a broadcast signal from a headend facility 14 to a subscriber viewing location or final destination 20.

As illustrated in FIG. 5A, an encryption encoder 120 is located at a national headend 122. The encoder 120 encrypts the broadcast signal before transmission of the signal to the system operator's satellite 16. The encryption of data leaving a national or local advertisement server located at the national headend 122 is for identity and security purposes. Transmissions from the national headend 122 to the operator's satellite 16 are thus secure transmissions. The broadcast signal may then be transmitted from the satellite 16 to a subscriber's final location 20, which includes but is not limited to out-of-home venues such as health clubs, malls, hospitals, schools, universities, businesses, military bases, and the like. As previously described, the broadcast signals from the satellite 16 may enter the final receiving location via a satellite dish 18 or any other method of receiving broadcast content. Although the headend 122 is described as a national headend, it will be readily understood that the headend may be regional or local.

As illustrated in FIG. 5B, transmissions via an internet protocol may be used to send broadcast and advertising content via the Internet from a headend 130 to a subscriber viewing location 20. The headend 130 may be a national headend, a regional headend, or a local headend. In one embodiment of a regional headend 130 that transmits content via an internet protocol to a final destination 20, the signal is received at the headend 130 by a satellite dish located at the headend 130. The signal then travels through a decryption decoder. Preferably all transmissions are in a convenient format, which includes but are not limited to MPEG-4 or H.264, to prepare the files for transmission via the Internet. If necessary, content is converted to the proper format via an encoding device 132. Content may also be encrypted for security purposes by an encryption device 134. If necessary, the signal is further converted to files compatible with transmission via the Internet. Such files enter a file or web server 136, which has the capability of receiving input from multiple encoders, and the files are routed from the headend 130 to a carrier 138. As will be readily understood, the file server 136 allows the files to be accessible via the Internet. Carriers 138 may include, but are not limited to T3, TI, Cable, DSL, telephone modem, wireless technologies, and others such arrangements that allow for the transportation of files via the Internet. The carrier 138 connects the final viewing location 20 with the file server 136 at the headend 130.

FIG. 6 illustrates an arrangement and methods of transmitting a broadcast signal from a national headend 140 to a subscriber's final viewing location 20. An encryption encoder 142 at the national headend 140 encrypts a broadcast signal for security and identification purposes. The signal is then transmitted to the system's satellite. Transmissions from the headend 140 to the satellite 16 are preferably secured. The broadcast signal is transferred from the satellite 16 to a regional headend 144, where a satellite dish 146 receives it. In an embodiment, national and local advertisement server systems may be present at the national headend 140 for purposes of advertisement insertion.

Transmissions from the national headend 140 to a regional headend 144 may be arranged in a number of ways to accommodate the regional headend 144. Regional headend locations may include but are not limited to cable television company facilities, such as Comcast and Time Warner Cable, and locations owned or leased by the system operator. If the regional headend 144 is at a cable company facility, the broadcast signals may be relayed through the cable company's existing network to the final receiving location 20. If the regional headend 144 is a facility owned or leased by the system operator, the signals may be transmitted to the final viewing location 20 via an internet protocol, such as that seen in FIG. 8. A regional advertisement server system 148 may be present at the regional headend 144 for purposes of regional advertisement insertion.

Receiving equipment at the final location 20 may be arranged in a variety of ways and is not limited to the examples provided herein. A satellite television receiver may decode and output the broadcast signal that includes broadcast and advertising content with advertisements inserted from the national advertisement server at the national headend 140 and regional advertisement server 150 at the regional headend 144B. A local content distribution receiver may decode and output the broadcast signal that includes broadcast content and advertising from a local advertisement server at the national or regional headends 140, 144B. In addition, a local advertisement server may be located at the subscriber viewing location 20 for advertisement insertion.

In an embodiment, a local content distribution receiver receives and stores playback triggers, advertisements, and other content sent by the local advertisement server at national or regional headend 140, 144B. The device may insert stored broadcast and advertising content into the broadcast signal according to the triggers received from the local content scheduler and server at the headends 140, 144B. In such a manner, locally, regionally, and nationally inserted content may be included in the broadcast signal output from the device so the targeted demographics audience at a health clubs or other desirable facilities receive the proper advertisements.

Signals from a local content distribution receiver may be directly input into a video monitor or standard NTSC television via methods such as composite, S-Video, component, HDMI, VGA, or DVI output ports. A modulator device may be used to combine signals output from the receivers with a third-party cable or satellite service on a single coaxial cable for viewing within the same channel line-tip. The modulator allows the signal output from the receiver to be assignable to a single channel on a standard NTSC television. Viewing equipment at the final location may be the standard type television or monitors. The broadcast may include national, regional, and local content and targeted advertisements that are easily viewed on one or more video monitors and televisions in each health club location.

Referring now to FIG. 8, transmission via an internet protocol to the final location 20 is illustrated. The receiving equipment at the final location 20 includes Internet hardware and software to Internet enable the final receiving location 20. In one embodiment, a first internet protocol television receiver 160, such as but not limited to an Amino AmiNet 124, receives files from the headend 162 via the Internet. The receiver 160 receives content from the broadcast signal that includes both broadcast content and advertising content inserted into the signal by the national advertisement server at the headend 162 and regional advertisement server at the regional headend 162. The receiver 160 may optionally buffer the files.

A second internet protocol television receiver 164 receives files via the Internet. This second receiver 164 receives content from the broadcast signal that includes broadcast and advertising content inserted by a local advertising server located at the headend 162. Alternatively, the local advertising server may be located at the final receiving location 20. This second receiver 164 may also buffer the files.

The second internet protocol television receiver 164 receives and stores playback triggers, advertisements, and content sent by the local advertisement server at the headend 162. The receiver 164 inserts stored targeted advertisements and content to the broadcast signal according to the triggers received from the local content scheduler and server at the headend 162. In such a manner locally, regionally, and nationally inserted content and targeted advertisements are included in broadcast programming output from the receivers 160, 164. Signals from the receivers 160, 164 may be directly input to a video monitor or standard NTSC television via methods such as composite, S-Video, component, HDMI, VGA, or DVI output ports.

A modulator device 166 may be used to combine signals output from the receivers 160, 164 with third-party cable or satellite services on a single coaxial cable for viewing within the same channel line-up. The modulator 166 allows the signal output from each receiver 160, 164 to be assignable to a single channel on a standard NTSC television. The broadcast signal may include national, regional, and local content and targeted advertisements viewed on one or more video monitors and televisions at each subscriber health club or other such location.

Although embodiments described and illustrated herein have been generally described as including a subscriber that is a health club, it will be readily understood that this disclosure is in no way limited by those descriptions and illustrations. For example, subscribers or end viewers may be any type of business or location where potential viewers gather, such as shopping malls, beauty shops, restaurants, hospitals, schools, universities, general businesses, military bases, and the like.

In addition, the present invention is not limited in anyway to stationary or immovable locations such as buildings. The embodiments described and illustrated are also applicable to broadcast signals relayed to airplanes for in flight viewing, or trains, busses, and other vehicles for viewing within such vehicles. In the example of an airplane or other such vehicle, the device that receives a broadcast signal with inserted advertising content may be a satellite dish, an antenna incorporated into the vehicle, or any other such device or technology that may receive such signals.

While the specific embodiments have been illustrated and described, numerous modifications come to mind without significantly departing from the spirit of the invention and the scope of protection is only limited by the scope of the accompanying claims.

What is claimed is:

1. A system for providing a service comprising:
a broadcast signal displayable on a video display device;
a facility for processing said broadcast signal, said facility including:
a first broadcast signal receiving device;
a broadcast signal modification device to modify said broadcast signal to a modified broadcast signal displayable on said video display device; and
a broadcast signal transmitting device for transmitting said modified broadcast signal;
a first signal directing device to direct said broadcast signal from a broadcast content provider to said facility; and
a second signal directing device to direct said modified broadcast signal from said facility to a final destination for display to end viewers.

2. The system of claim 1, where said broadcast signal comprises an original programming portion and an original advertising portion.

3. The system of claim 2, where said broadcast signal modification device modifies said broadcast signal by removing said original advertising portion and inserting a targeted advertising portion to form said modified broadcast signal.

4. The system of claim 3, where said broadcast signal modification device modifies said broadcast signal to said modified broadcast signal in real time and said modified broadcast signal is received at said final destination in real time.

5. The system of claim 3, where said targeting advertisement portion is selected to match characteristics of said end viewers.

6. The system of claim 3, where said targeted advertising portion is selected based on whether said modified broadcast signal is intended for local distribution, regional distribution, or national distribution.

7. The system of claim 1, where an advertisement content provider directs advertisement content to said facility and said broadcast signal modification device modifies said broadcast signal to said modified broadcast signal by inserting said advertisement content into said broadcast signal.

8. The system of claim 1, where said final destination includes:
a second broadcast signal receiving device; and
a plurality of display devices, each said display device capable of displaying at least a portion of said modified broadcast signal.

9. The system of claim 1, where said facility further includes:
a broadcast signal decoding device; and
a broadcast signal encrypting device.

10. A system for providing a service comprising:
digital broadcast content;
targeted digital advertising content;
a transmission device for transmitting said digital broadcast content through an internet protocol;
a receiving device for receiving said digital broadcast content thorough an internet protocol;
a modification device for modifying said digital broadcast content; and
a display device for displaying said digital broadcast content after modification.

11. The system of claim 10, where said digital broadcast content comprises original digital programming content and original digital advertising content.

12. The system of claim 11, where said original digital advertising content is removed from said digital broadcast content and replaced with said targeted digital advertising content.

13. The system of claim 12, further including a headend and a viewing destination proximate to said display device.

14. The system of claim 13, where said modification device is located at said headend.

15. The system of claim 13, where said modification device is located at said viewing destination.

16. The system of claim 10, where said modification device modifies said digital broadcast content in real time.

17. A method for providing a broadcast signal comprising:
receiving a broadcast signal from a broadcast content provider;
receiving advertisement content from an advertising content provider;
inserting said advertisement content into broadcast signal to form a modified broadcast signal; and
sending modified broadcast signal to an end viewer for viewing.

18. The method of claim 17, further comprising removing original advertisement content from said broadcast signal.

19. The method of claim 17, further comprising selecting said advertisement content to insert into said broadcast signal based on intended end viewer.

20. The method of claim 17, further comprising selecting said advertisement content based on whether distribution of said modified broadcast signal is intended to be local, regional, or national.
